(19) United States
(12) Patent Application Publication
(10) Pub. No.: US 2005/0134897 A1
(43) Pub. Date: Jun. 23, 2005

(54) Image forming apparatus

(75) Inventor: Kouichi Mase, Narashino-shi (JP)

Correspondence Address: FOLEY AND LARDNER;SUITE 500, 3000 K STREET NW, WASHINGTON, DC, 20007, US

(73) Assignee: TOSHIBA TEC KABUSHIKI KAISHA

(21) Appl. No.: 10/392,882

(22) Filed: Mar. 21, 2003

(51) Int. Cl. G06F 3/12; G06F 13/00

(52) U.S. Cl. 358/1.15; 358/1.16

(57) ABSTRACT

The image forming apparatus, when receiving print data to which an instruction of storing the data to the print data storage source is added from the print data supply source, acquires address data for storing the received print data, from the print data storage source. The apparatus converts the obtained address data into predetermined code symbol data, and stores the received print data in the print data storage source on the basis of the obtained address data. The apparatus adds the converted code symbol data to a predetermined location of the received print data, and print out the data.

### BACKGROUND OF THE INVENTION

1. Field of the Invention

The present invention relates to an image forming apparatus having a function of connecting itself to a network.

2. Description of the Related Art

Image forming apparatus that receives printing data such as document data or an image file formed with a computer device and forms an image from the received data are conventionally known. For example, a local printer is connected directly to a computer device with use of a parallel port, via which print data that contain character data, image data, control code and the like, are received and thus received data are printed on a print recording medium. On the other hand, in the case of a network printer such as a photocopier having a network function, it is shared by a plurality of computer devices via a network, and it receives print data via the network and print it on a print recording medium.

In general, there are two known methods of storing print data, one is to store then in a computer device and the other is to store them in an image forming apparatus. In the case of storing print data in a computer device, it is necessary, when carrying out printing, for the user to first start the computer device and then transmit the print data to the image forming apparatus, which takes time and labor. On the other hand, in the case of storing print data-in the image forming apparatus, there is no need to carry out starting of the computer device and the like, however it is still necessary for the user to call up the print data by manipulating the operation panel at the place where the image forming apparatus is installed each time the user carries out the printing. In this case, if the user is not able to operate the apparatus while being away from the office for business trip or the like, the print data cannot be printed out. Further, there are some cases where a print image is copied from a printed sheet. For example, in the case of a photocopier, the image is read with a scanner function, and the image is copied from the read image-data by the electrophotographic mode. However, the print image quality is inevitably deteriorated when a printed recording medium is copied.

Therefore, there is a need for an image forming apparatus that can easily call up print-data from any one of image forming apparatus connected to a network, and print the data, and that can prevent the deterioration of the image quality when printing.

### BRIEF SUMMARY OF THE INVENTION

According to an aspect of the present invention, there is provided an image forming apparatus comprising: a connection portion configured to connect the apparatus via a network to a print data storage source for storing print data and a print data supply source for supplying the print data; a receiving portion configured to receive the print data from the print data supply source via the connection portion; and a judgment portion configured to judge whether or not the received print data is provided with an instruction added thereto for storing the data in the print date storage source. Further, the apparatus comprises an address acquisition portion configured to acquire address data for storing the received print data in the print data storage source, from the print data storage source via the connection portion, when it is judged that the instruction is added to the print data; and a storage portion configured to store the print data in the print data storage source on the basis of the acquired address data. Moreover, the apparatus comprises a code symbol conversion portion configured to convert the acquired address data into predetermined code symbol data; an adder portion configured to add the converted code symbol data to a predetermined location of the received print data; and a print portion configured to print the print data added with the code symbol data.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a diagram illustrating a network structure in an embodiment of the present invention;

FIG. 2 is a diagram showing a brief control structure of an MFP;

FIG. 3 is a diagram showing a brief control structure of a PC;

FIG. 4 is a diagram showing a brief control structure of a server;

FIG. 5 is a flowchart illustrating a process for storing an image;

FIG. 6 is a diagram showing an example of printing of a code symbol;

FIG. 7 is a flowchart illustrating a process for reproducing an image;

FIG. 8 is a diagram showing another example of printing of the code symbol;

FIG. 9 is a diagram showing still another example of printing of the code symbol; and

FIG. 10 is a diagram showing still another example of printing of the code symbol.

### DETAILED DESCRIPTION OF THE INVENTION

An embodiment of the present invention will now be described with reference to accompanying drawings. This embodiment will be described in a case where the present invention is applied to multi-function peripherals (MFP) 5 having functions of printer, scanner, communication and the like.

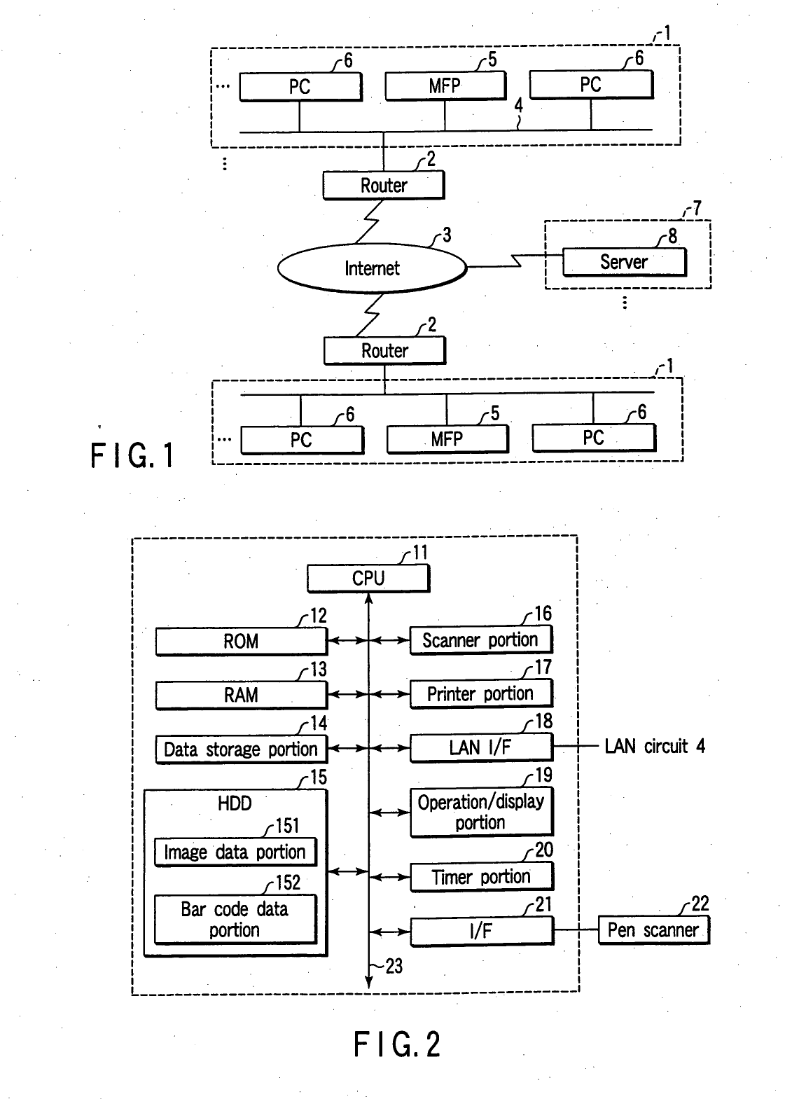

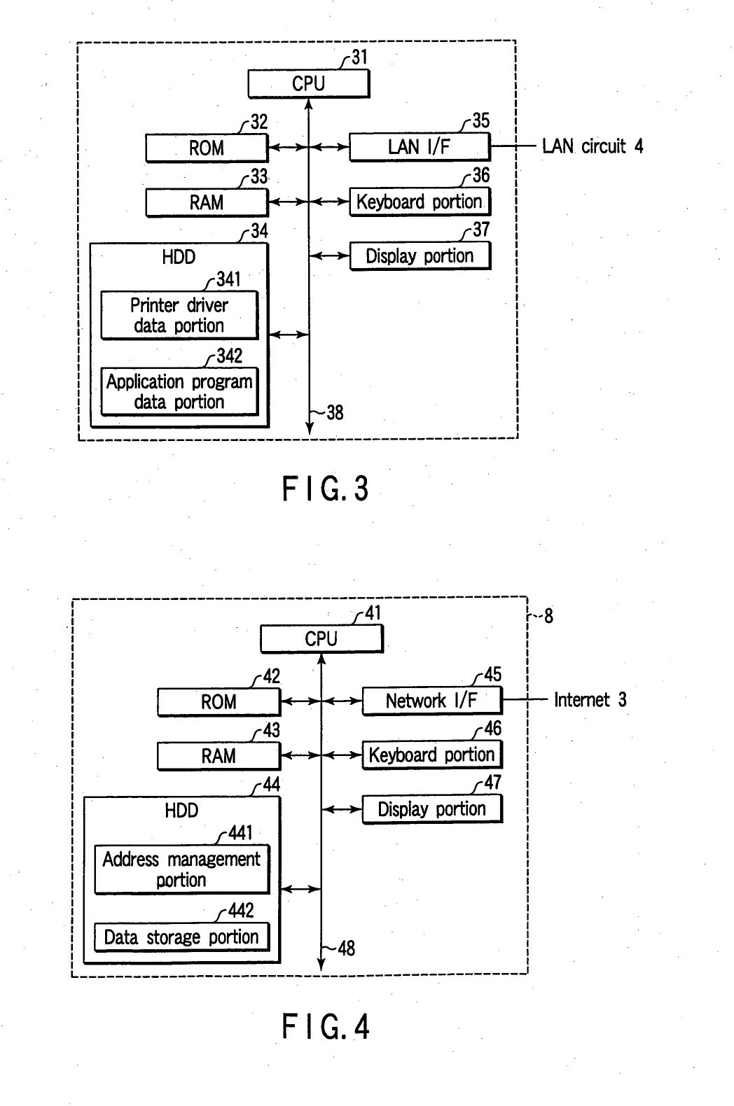

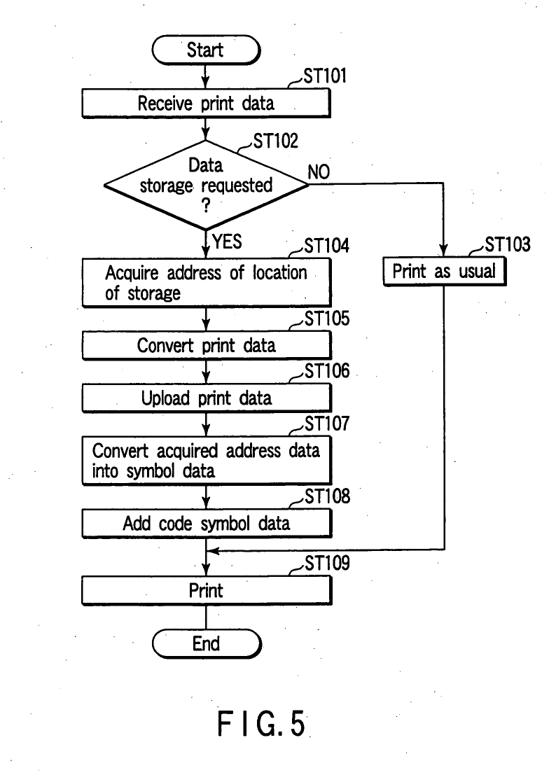

FIG. 1 is a diagram illustrating a structure of a network. As shown, a LAN 1 in which a local area network (LAN) is formed is connected to the Internet 3 via a router 2. In addition to the router 2, MFP 5 and a plurality of PCs 6 (print data supply sources) are connected to a LAN circuit 4. A plurality of LANs 1 each having the above-described structure are connected to the Internet 3. Further, a server 8 (print data storage source) installed in a service provider 7 that provides services of storing image data is connected to the Internet 3. Note that it is also possible that a plurality of service providers 7 in each of which the server 8 is installed are involved although the figure shows only one provider 7.

Next, the brief structure of the MFP 5 described above will now be explained with reference to FIG. 2. The MFP 5 is provided with a CPU 11, ROM 12, RAM 13, a data storage portion 14, a hard disk drive (HDD) 15, a scanner portion 16, a printer portion 17, a LAN interface (I/F) 18, an operation/display portion 19, a timer portion 20, and an interface (I/F) 21. The I/F 21 is, for example, a universal serial bus (UBS), to which a pen scanner 22 is connected. The CPU 11 is connected to each of the ROM 12, RAM 13, the data storage portion 14, HDD 15, the scanner portion 16, the printer portion 17, LAN I/F 18, the operation/display portion 19, the timer portion 20 and the I/F 21 via a bus line 23.

The CPU 11 overall controls each of the parts on the basis of the control program stored in the ROM. 12 and thus realize the operations of the MFP 5. The ROM 12 stores the control program and the like, executed by the CPU 11. The RAM 13 is used as, for example, a work area for storing various data necessary for the CPU 11 to carry out various types of processes.

The data storage portion 14 is made of, for example, a flash memory and the like, and it stores various kinds of set data and other kinds of data. The HDD 15 temporarily stores print data received and image data read with the scanner portion 16. Further, the HDD 15 is provided with an image data portion 151 and a bar code data portion 152.

The image data portion 151 stores a control program used to convert image data into a predetermined data format. Examples of the predetermined data format are general data formats such as the postscript (PS), page descriptive language (PDL), (TIF), portable document format (PDF), joint photographic experts group (JPEG), and bit map. The bar code data portion 152 stores a control program used to convert the address data of the server 8 used in the Internet 3, for example, its URL or the storage location of the data of the server 8, into a optically readable code symbol, and to convert code symbol data generated by optically reading the code symbol into the address data. An example of the code symbol is a bar code. The HDD 15 stores a control program used to store image data in the server 8 and a control program used to download image data from the server 8 and reproduce the image.

The scanner portion 16 is used to read the image of an original sheet-placed on the original sheet table, which is not shown in the figure, and generate the image data. The printer portion 17 print out the image data generated by the scanner portion 16 or the print data received via the LAN I/F 18, onto a print recording medium.

The LAN I/F 18 is used to connect the apparatus to the LAN circuit 4. The MFP 5 carries out data communications with the server 8 via the LAN I/F 18, LAN circuit 4, router 2, and the Internet 3.

The operation/display portion 19 is provided with a key input portion and a touch panel. The key input portion accepts various kinds of instruction inputs to the CPU 11 made by the user. For example, it is provided with a start key to start printing or copying. The touch panel displays various kinds of data to be informed to the user under the control of the CPU 11. Further, the touch panel accepts, on the basis of the predetermined display, instruction inputs made by the user.

The timer portion 20 carries out the timing operation at all times, and outputs present time data indicates the present time. As described above, the pen scanner 22 is connected to the I/F 21. The pen scanner emits light at all times, and when it is scanned by the user on a bar code, the scanner reads the bar code.

Further, in the MFP 5 having the above-described structure, the control programs to be executed by the CPU 11 and stored in the ROM 12 includes, in addition to those described above, general control programs for the MFP 5.

Next, a brief structure of the PC 6 will now be described with reference to drawings. The PC 6 includes a CPU 31, ROM 32, RAM 33, HDD 34, LAN I/F 35, a keyboard portion 36 and a display portion 37. The CPU 31, ROM 32, RAM 33, HDD 34, LAN I/F 35, the keyboard portion 36 and the display portion 37 are connected to each other via bus lines 38. With this structure, the PC 6 is able to carry out data communications with the MFP 5 and server 8. Please note that the structures employed in the present invention are general for PCs, and therefore the detailed description will be omitted here.

In the HDD 34, a printer driver data portion 341 in which a printer driver containing predetermined print commands is stored, and an application program data portion 342 in which a word processor software, a drawing software and the like are stored, are provided. The printer driver data portion 341 forms print data on the basis of a predetermined print command by interpreting data input with use of the application programs with reference to font memory and the like. Further, the printer driver is designed such as to be able to add data indicating whether or not print data is to be stored in a header portion of the print data. The user is able to add the data by changing the program of the printer driver displayed when printing using various types of applications. Further, in the header portion of the print data, the LAN address of a designated MFP 5 and control code are added.

Next, a schematic structure of the server 8 will now be described with reference to drawings. The server 8 is provided with a CPU 41, ROM 42, RAM 43, HDD 44, a network I/F 45, a keyboard portion 46 and a display portion 47. The CPU 41, ROM 42, RAM 43, HDD 44, network I/F 45, keyboard portion 46 and display portion 47 are connected to each other via bus lines 48. The server 8 has a URL on the Internet 3. With this structure, the server 8 is able to carry out data communications with the MFP 5. It should be noted that the structures employed here for the server 8 are general ones, and therefore the detailed descriptions will be omitted here.

The HDD 44 is provided with an address management portion 441 and a data storage portion 442. The address management portion 441 is used to assign an address in a predetermined case for carrying out the management of image data to be stored. The data storage portion 442 serves to store image data.

Next, the processes that are executed by the CPU 11 of the MFP 5 when receiving print data from the PC 6 and storing the data in the server 8 in the network having the above-described structure, will now be described.

In Step ST101, the CPU 11 receives print data from the PC 6 via the LAN I/F 18. The print data is stored in a predetermined area of the HDD 15. In Step ST102, the CPU 11 judges whether or not data indicating to store the print data have been added to the header portion of the print data. If the result of the judgment is “NO”, the process proceeds to Step ST103, whereas if “YES”, it proceeds to. Step ST104.

In Step ST103, the CPU 11 carries out an ordinary process for the case of receiving print data, in which the printer language of the print data is interpreted by controlling the printer portion 17 and the image data obtained by developing the print data into an image is printed out. Thus, the printing is carried out and the process is finished.

In Step ST104, the CPU 11 conducts communications with the server 8 via the Internet 3, and acquires address data used to store image data from the server 8. The address data contain the URL of the server 8 as well. When accessed by the CPU 11 of the MFP 5 in order to store image data, the server 8 assigns a predetermined address to it. Further, the accessing to a server by the CPU 11 may be carried out in such a manner that a plurality of serves access a preset server. In this case, the URLs of the servers are pre-stored, and therefore only the address data relating to the storage location of the image data in the server 8 is required. Therefore, the data conversion can be finished in a short period of time. Thus acquired address data is stored in, for example, a predetermined area of the RAM 13.

In Step ST105, the CPU 11 converts the print data stored in the HDD 15 into image data, which is more versatile. More specifically, the CPU 11 interprets the printer language from the header portion of the print data, and develops the print data into image data. Then, the CPU 11 converts thus developed image data into the format of image data, which is more versatile. Examples of the format of the image data are, as described before, PS, PDL, TIF, PDF, JPEG, bit map, etc.

In Step ST106, the CPU 11 uploads the image data to the address acquired above. The server 8 stores the image data uploaded to the address that has been assigned to the MFP 5 in order to store the image data. In this manner, the image data is stored in a predetermined area of the data storage portion 442 of the server 8. It should be noted that in this Embodiment, versatile image data is stored on the server 8, but it is also possible that print data is directly stored in the server 8. With this structure, it is possible to shorten the time required to convert print data in such a network environment in which MFPs 5 that use the same printer language are connected.

In Step ST107, the CPU 11 converts the address data stored in the RAM 13 into optically readable code symbol data. The code symbol data is, for example, a bar code.

In Step ST108, the CPU 11 adds the bar code data to a predetermined location of the image data that has been developed into an image. In this embodiment, the bar code data is overwritten on the predetermined location of the image data. It should be noted that if the location data that is used to print the code symbol data by the printer driver of the PC 6, is added to the header portion of the image print data, the printing is carried out on the basis of that location data. With this structure, the invention is effective for the case where an image that is to be printed cannot be printed out when the printing is carried out by default.

In Step ST109, the CPU 11 controls the printer portion 17 to print out the image data in which the bar code data has been overwritten on the predetermined location.

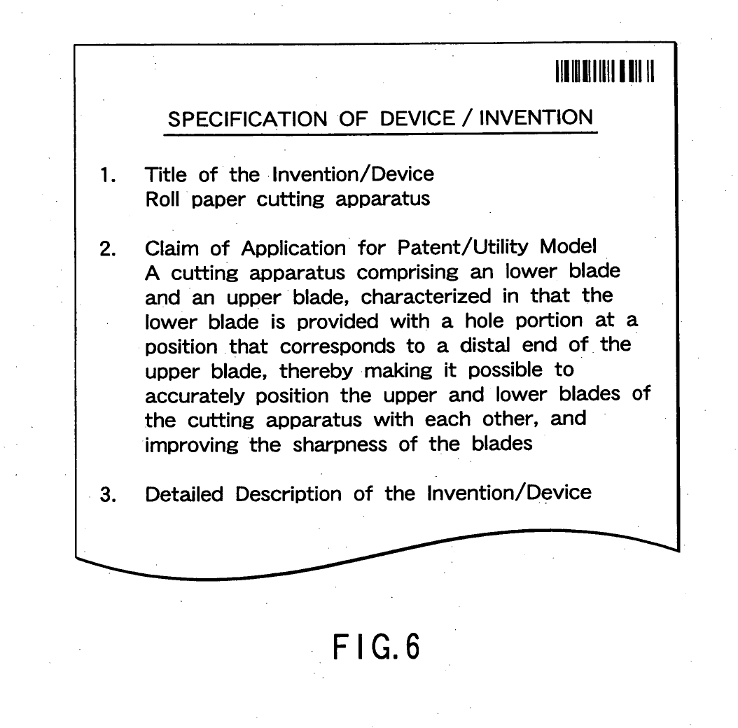

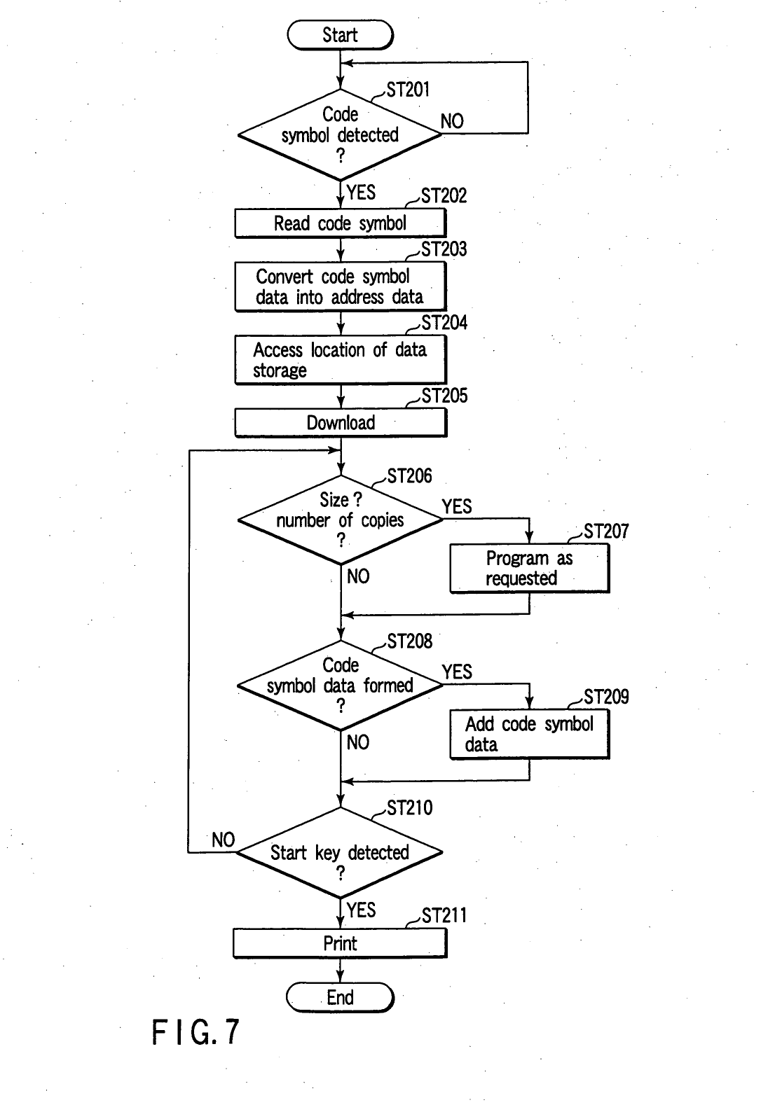

FIG. 6 shows an example in which the print data is processed as described above. As shown in the figure, a bar code is printed in an upper right section of the print recording medium.

Next, the process executed by the CPU 11 of the MFP 5 in the case where the user reproduces an image with use of a print recording medium thus printed, will now be described.

In Step ST201, the CPU 11 judges whether or not the code symbol is detected. This judgment is made based on, for example, whether or not the data provided at an end portion of the bar code, which indicates that it is a bar code, is read when the user scans the pen scanner 22 on the bar code. If the judgment indicates “YES”, the process proceeds to Step ST202, whereas if it indicates “NO” the process is set in a standby state until the judgment of “YES” is indicated.

In Step ST202, the CPU 11 reads the code symbol with the pen scanner 22. Then, code symbol data such as bar code data is generated on the base of thus read code symbol, and the generated data is stored in a predetermined area of the RAM 13.

In Step ST203, the CPU 11 converts the bar code data stored in the RAM 13 into address data. In this manner, the address of the server 8 that stores image data printed on a print recording medium on which the bar code is printed, and the data of the storage location in the server 8 are acquired.

In Step ST204, the CPU 11 accesses the location where the image data is stored in the server 8 via the Internet 3. Then, in Step ST205, the CPU 11 downloads the image data from the storage location of the data storage portion 442 of the server 8. The downloaded image data is stored in the HDD 15.

Subsequently, in Step ST206, the CPU 11 judges whether or not the requests of size, number of copies, etc. are input from the operation/display portion 19. If the judgment indicates “YES”, the process proceeds to Step ST207, whereas if it indicates “NO”, the process proceeds to Step ST208. Note that if the judgment indicates “NO”, it is programmed by default. In the program set by default, the size is the same as that when the image data was stored, and the number of copy is one. In Step ST207, the CPU 11 sets the required size and required number of copies.

In Step ST208, the CPU 11 judges whether or not there has been a request of adding a code symbol to image data from the operation/display portion 19. If the judgment indicates “YES”, the process proceeds to Step ST209, whereas if it indicates “NO”, the process proceeds to. Step ST210. In Step ST209, the bar code data is overwritten at the predetermined location of the image data stored in the HDD 15.

In Step ST211, the CPU 11 judges whether or not the input of a start key has been detected. If the judgment indicates “YES”, the process proceeds to Step ST211, whereas if it indicates “NO”, the process returns to Step ST206. In Step ST210, the CPU 11 controls the printer portion 17 and print out the image data based on various set programs. Then, the CPU 11 finishes the process.

The MFP 5 is structured as described above. With the described structure, the user can transmit print data to which code symbol data has been added from the PC 6 by using the MFP 5, and thus obtain a printout on a print recording medium on which the code symbol is printed. By keeping in hand only one copy of thus printed recording medium, the user can easily obtain the image data from the server 8 and print it out anywhere in the world if the MFP 5 having the above-described functions is installed. Further, the user only has to read bar code data with a reading device such as the pen scanner 22, and thus the code symbol reading operation is simple. Furthermore, since the image is not read from an original sheet, it is possible to prevent the degradation of the image quality.

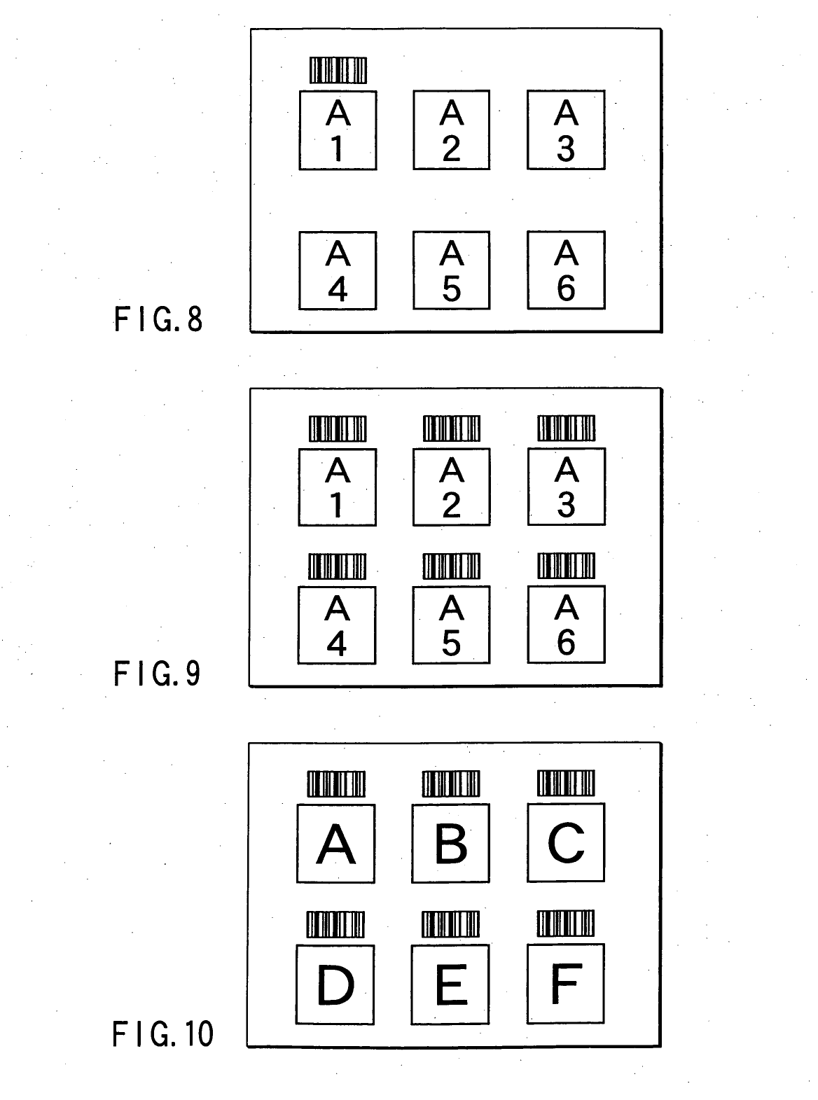

Moreover, the MFP 5 has an editing function called Nin 1, with which a plurality (N-number) of original sheets are reduced in size and they are printed on one sheet. With use of this function, in the case where, for example, 6 pages of sheets (A1, A2, A3, A4, A5 and A6) are to be printed out from one print data by utilizing the MFP 5 with manipulation of the PC 6, it is possible that the user prints out the images of the 6 sheets on one sheet and provides one code symbol for that sheet as shown in FIG. 8. Or in the case where the contents of these six sheets are different from each other although they are somehow related to each other, it is possible that a respective code symbol is printed in a section adjacent to each of the respective pages as can be seen in FIG. 9.

It is alternatively possible that code symbols are assigned respectively to pages of, for example, a catalogue having different contents (A, B, C, D, E and F) from one page to another, and a code symbol is printed at a section near the corresponding sheet. In this case, naturally, the image data corresponding to the address of the server 8 that corresponds to the code symbol is stored. Therefore, the user is only required to read the code symbol printed near the desired image data with the pen scanner 22, and print out the image data acquired from the server 8. In this manner, the original image data can be printed out in a desired size without degrading the quality of the image.

In the above-described embodiment, a code symbol is read with the pen scanner 22; however it is alternatively possible to provide the MFP 5 with a mode for reading a code symbol from a predetermined location of a print recording medium. In this case, the user can set a print recording medium on an original sheet table, and call the mode from the operation/display portion to read code symbols by the scanner portion 16. With this structure, it is not required to provide the pen scanner 22 for the MFP 5, thus making it possible to carry out the present invention at a lower cost.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

1. An image forming apparatus comprising:
a connection portion configured to connect the apparatus via a network to a print data storage source for storing print data and a print data supply source for supplying the print data;
a receiving portion configured to receive the print data from the print data supply source via the connection portion;
a judgment portion configured to judge whether or not the received print data is provided with an instruction added thereto for storing the data in the print date storage source;
an address acquisition portion configured to acquire address data for storing the received print data in the print data storage source, from the print data storage source via the connection portion, when it is judged that the instruction is added to the print data;
a storage portion configured to store the print data in the print data storage source on the basis of the acquired address data;
a code symbol conversion portion configured to convert the acquired address data into predetermined code symbol data;
an adder portion configured to add the converted code symbol data to a predetermined location of the received print data; and
a print portion configured to print the print data added with the code symbol data.

2. The image forming apparatus according to claim 1, further comprising:
a reading portion configured to read a code symbol from an original sheet on which the code symbol is printed at the predetermined location;
an address conversion portion configured to, convert code symbol data that has been generated on the basis of the read code symbol into address data; and
a print data acquiring portion configured to accessing the print data storage source via the connection portion on the basis of the converted address data and acquire print data stored at the address from the print data storage source,
wherein the print portion further prints out the print data obtained by the print data acquiring portion.

3. A method of storing an image of an image forming apparatus connected to a print data storage source for storing print data and a print data supply source for supplying the print data, via a network, said method comprising:
receiving the print data from the print data supply source;
judging whether or not the received print data is provided with an instruction added thereto for storing the data in the print date storage source;
acquiring an address for storing the received print data in the print data storage source, from the print data storage source, when it is judged that the instruction is added to the print data;
accessing the print data storage source on the basis of the acquired address data and storing the received print data therein;
converting the acquired address data into predetermined code symbol data;
adding the converted code symbol data to a predetermined location of the received print data; and
printing the print data added with the code symbol data.

4. A method of reproducing an image of an image forming apparatus connected to a print data storage source for storing print data via a network, said method comprising:
reading a code symbol from an original sheet on which the code symbol indicating the print data storage source is printed;
converting code symbol data that has been generated on the basis of the read code symbol into address data;
accessing the print data storage source on the basis of the converted address data and acquiring print data stored at the address from the print data storage source; and
printing out the acquired print data.
